(19) United States
(12) Patent Application Publication
(10) Pub. No.: US 2016/0110037 A1
(43) Pub. Date: Apr. 21, 2016

(54) ELECTRONIC APPARATUS, STORAGE MEDIUM, AND METHOD FOR OPERATING ELECTRONIC APPARATUS

(71) Applicant: KYOCERA Corporation, Kyoto-shi (JP)

(72) Inventors: Shinsuke MORIAI, Osaka (JP); Eita KATSU, Yokohama-shi (JP)

(73) Assignee: KYOCERA Corporation

(21) Appl. No.: 14/978,238

(22) Filed: Dec. 22, 2015

Related U.S. Application Data
(63) Continuation of application No. PCT/JP2014/066845, filed on Jun. 25, 2014.

(30) Foreign Application Priority Data
Jun. 26, 2013 (JP) 2013-134158

(51) Int. Cl. G06F 3/0482; G06F 3/0484; G06F 3/0488; G06T 3/40

(52) U.S. Cl. CPC G06F 3/0482; G06T 3/40; G06F 3/04845; G06F 3/04883

(57) ABSTRACT

An electronic apparatus includes a display, an operation detector configured to detect an operation performed with an operator on the display, a time counter configured to measure a contact time, and a processor configured to run an application program corresponding to an image displayed by the display. The image includes a first image displayed by the display at a first size or a second size smaller than the first size. In a case where the display displays, at the second size, the first image including a graphic representing the corresponding application program and not including text information, the processor causes the display to display the text information when the operator is in contact with the first image, and the contact time with the first image is longer than a first threshold.

### CROSS-REFERENCE TO RELATED APPLICATIONS

The present application is a continuation of PCT Application No. PCT/JP2014/066845, filed on Jun. 25, 2014, which claims the benefit of Japanese Patent Application No. 2013-134158, filed on Jun. 26, 2013. PCT Application No. PCT/JP2014/066845 is entitled “ELECTRONIC DEVICE, MEMORY, AND METHOD FOR OPERATING ELECTRONIC DEVICE”, and Japanese Patent Application No. 2013-134158 is entitled “ELECTRONIC DEVICE, CONTROL PROGRAM, AND OPERATING METHOD”. The contents of which are incorporated by reference herein in their entirety.

### FIELD

Embodiments of the present disclosure relate to electronic apparatuses.

### BACKGROUND

Various techniques concerning electronic apparatuses have been proposed.

### SUMMARY

An electronic apparatus, a storage medium, and a method for operating an electronic apparatus are disclosed. In one embodiment, an electronic apparatus includes storage, a display, an operation detector, a time counter, a generator, and a processor. The storage is configured to store at least one application program. The display is configured to display an image that corresponds to the application program and has a variable size. The operation detector is configured to detect an operation performed with an operator on the display. The time counter is configured to measure a contact time of the operator with the image based on results of detection by the operation detector. The generator is configured to specify a size of the image. The processor is configured to run the application program corresponding to the image when an operation performed with the operator on the image is detected. The image includes a first image displayed by the display at a first size or a second size smaller than the first size. In a case where the display displays the first image at the first size, the first image includes text information and a graphic representing the application program corresponding to the first image. In a case where the display displays, at the second size, the first image including the graphic representing the corresponding application program and not including the text information, the processor causes the display to display the text information when the operator is in contact with the first image, and the contact time with the first image is longer than a first threshold.

In one embodiment, a non-temporary storage medium readable by a computer stores a program. The program causes an electronic apparatus to perform the steps (a), (b), (c), and (d). The electronic apparatus includes storage configured to store at least one application program and a display configured to display an image that corresponds to the application program and has a variable size. The step (a) is a step of detecting an operation performed with an operator on the display. The step (b) is a step of measuring a contact time of the operator with the image based on results of detection in the step (a). The step (c) is a step of specifying a size of the image. The step (d) is a step of running the application program corresponding to the image when an operation performed with the operator on the image is detected in the step (a). The image includes a first image displayed by the display at a first size or a second size smaller than the first size. In a case where the display displays the first image at the first size, the first image includes text information and a graphic representing the application program corresponding to the first image. In the step (d), (d-1) in a case where the display displays, at the second size, the first image including the graphic representing the corresponding application program and not including the text information, the display is caused to display the text information when the operator is in contact with the first image, and the contact time with the first image is longer than a first threshold.

In one embodiment, a method for operating an electronic apparatus includes the steps (a), (b), (c), and (d). The electronic apparatus includes storage configured to store at least one application program and a display configured to display an image that corresponds to the application program and has a variable size. The step (a) is a step of detecting an operation performed with an operator on the display. The step (b) is a step of measuring a contact time of the operator with the image based on results of detection in the step (a). The step (c) is a step of specifying a size of the image. The step (d) is a step of running the application program corresponding to the image when an operation performed with the operator on the image is detected in the step (a). The image includes a first image displayed by the display at a first size or a second size smaller than the first size. In a case where the display displays the first image at the first size, the first image includes text information and a graphic representing the application program corresponding to the first image. In the step (d), (d-1) in a case where the display displays, at the second size, the first image including the graphic representing the corresponding application program and not including the text information, the display is caused to display the text information when the operator is in contact with the first image, and the contact time with the first image is longer than a first threshold.

### BRIEF DESCRIPTION OF DRAWINGS

FIG. 1 illustrates a front view showing the appearance of an electronic apparatus according to one embodiment.

FIG. 2 illustrates a back view showing the appearance of the electronic apparatus according to one embodiment.

FIG. 3 illustrates a block diagram showing electrical configuration of the electronic apparatus according to one embodiment.

FIG. 4 illustrates an example of display of the electronic apparatus according to one embodiment.

FIG. 5 illustrates an example of display of the electronic apparatus according to one embodiment.

FIG. 6 illustrates images displayed by the electronic apparatus according to one embodiment.

FIG. 7 illustrates functional configuration of the electronic apparatus according to one embodiment.

FIG. 8 illustrates a flow of processing performed by the electronic apparatus according to one embodiment.

FIG. 9 illustrates processing performed by the electronic apparatus according to one embodiment.

FIG. 10 illustrates processing performed by the electronic apparatus according to one embodiment.

FIG. 11 illustrates an example of display of the electronic apparatus according to one embodiment.

FIG. 12 illustrates an example of display of the electronic apparatus according to one embodiment.

FIG. 13 illustrates an example of display of the electronic apparatus according to one embodiment.

FIG. 14 illustrates an example of display of the electronic apparatus according to one embodiment.

FIG. 15 illustrates an example of display of the electronic apparatus according to one embodiment.

FIG. 16 illustrates an example of display of the electronic apparatus according to one embodiment.

FIG. 17 illustrates a flow of processing performed by an electronic apparatus.

FIG. 18 illustrates an example of display of an electronic apparatus according to a modification.

FIG. 19 illustrates an example of display of an electronic apparatus according to a modification.

FIG. 20 illustrates images displayed by an electronic apparatus according to a modification.

FIG. 21 illustrates an example of display of an electronic apparatus according to a modification.

FIG. 22 illustrates an example of display of an electronic apparatus according to a modification.

FIG. 23 illustrates images displayed by an electronic apparatus according to a modification.

FIG. 24 illustrates an example of display of an electronic apparatus according to a modification.

### DETAILED DESCRIPTION

<Appearance of Electronic Apparatus>

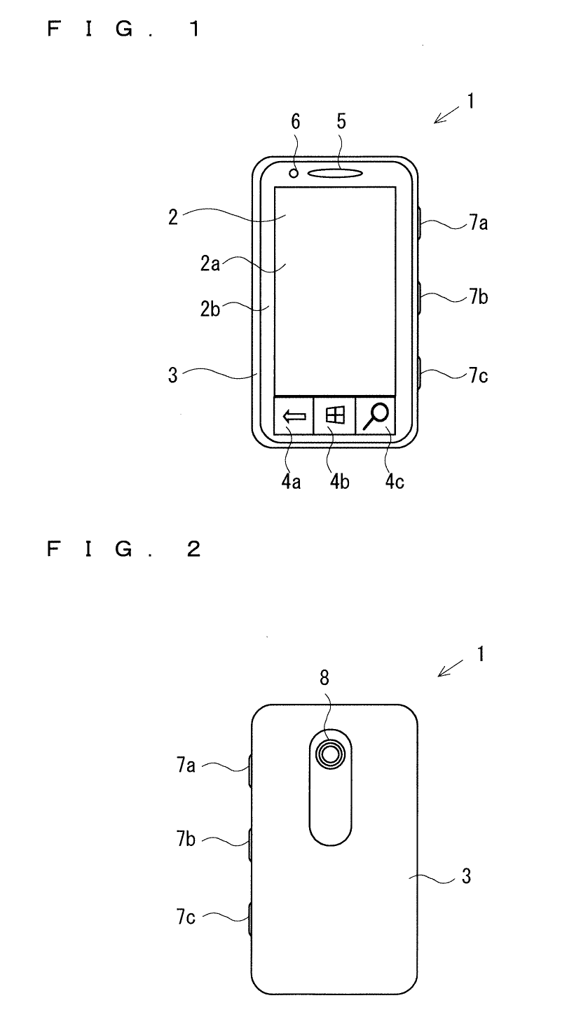

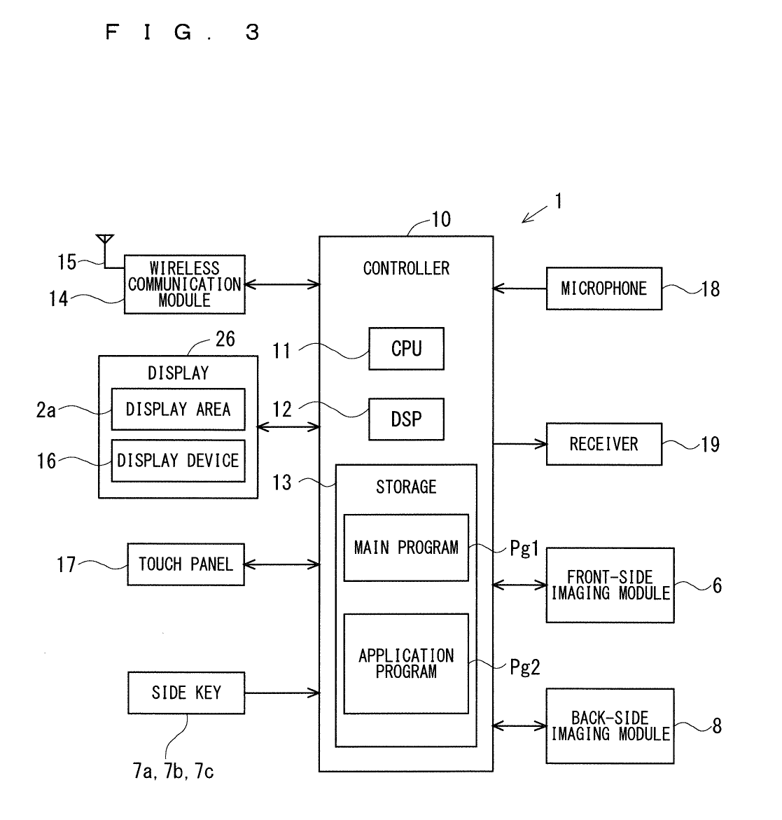

FIGS. 1 and 2 respectively illustrate a front view and a back view showing the appearance of an electronic apparatus 1 according to one embodiment. The electronic apparatus 1 according to one embodiment is a mobile phone, for example, and can communicate with another communication apparatus through a base station, a server, and the like. As illustrated in FIGS. 1 and 2, the electronic apparatus 1 has an approximately rectangular plate-like shape in a plan view, and includes a cover panel 2 and a case part 3.

As illustrated in FIG. 1, the cover panel 2 has a display area 2a, a peripheral area 2b, and operation keys 4a, 4b, and 4c. The cover panel 2 is made, for example, of transparent glass or a transparent acrylic resin. A display device 16 and a touch panel 17, which are described below, are provided on a back side of the cover panel 2.

A variety of information, including characters, signs, graphics, and images, displayed by the display device 16 is viewed by a user through the display area 2a of the cover panel 2. The peripheral area 2b, which surrounds the display area 2a, of the cover panel 2 is black, for example, because a film or the like has been applied thereto. Display of the display device 16 is not viewed by the user in the peripheral area 2b. The display area 2a of the cover panel 2 and the display device 16 are collectively referred to as a display 26. Information displayed by the display 26 is viewed from the outside the electronic apparatus.

The touch panel 17 can receive operations performed on the display area 2a and the operation keys 4a, 4b, and 4c with an operator, such as a finger. The operation keys 4a, 4b, and 4c are software keys in one embodiment. The operation key 4a is an operation key to return display of the display 26 to a preceding state, for example. The operation key 4b is an operation key to cause the display 26 to display a start screen (an initial screen), for example. The operation key 4c is an operation key to cause the display 26 to display a search screen, for example. A graphic, characters, or the like representing the operation key 4a is/are printed on the operation key 4a. Similarly, a graphic, characters, or the like representing the operation key 4b is/are printed on the operation key 4b. A graphic, characters, or the like representing the operation key 4c is/are printed on the operation key 4c. The graphics, characters, or the like representing the operation keys 4a, 4b, and 4c may not be printed, and may be displayed by the display device 16. The operation keys 4a, 4b, and 4c may not be the software keys, and may be hardware keys.

The cover panel 2 has a receiver hole 5 and a front-side imaging module 6 in an upper end portion thereof. Side keys 7a, 7b, and 7c are provided on a side of the electronic apparatus 1. The side key 7a is an operation key to adjust the volume of sound output from a receiver. The side key 7b is an operation key to activate the electronic apparatus 1. This means that the side key 7b is an operation key to power on or off the electronic apparatus 1. The side key 7c is an operation key to cause a back-side imaging module 8 to capture an image. As illustrated in FIG. 2, the electronic apparatus 1 has the back-side imaging module 8 on a back side thereof.

<Electrical Configuration of Electronic Apparatus>

FIG. 3 illustrates a block diagram showing electrical configuration of the electronic apparatus 1. As illustrated in FIG. 3, the electronic apparatus 1 includes a controller 10, a wireless communication module 14, the display 26, the touch panel 17, the operation keys 4a, 4b, and 4c, the side keys 7a, 7b, and 7c, a microphone 18, a receiver 19, the front-side imaging module 6, and the back-side imaging module 8.

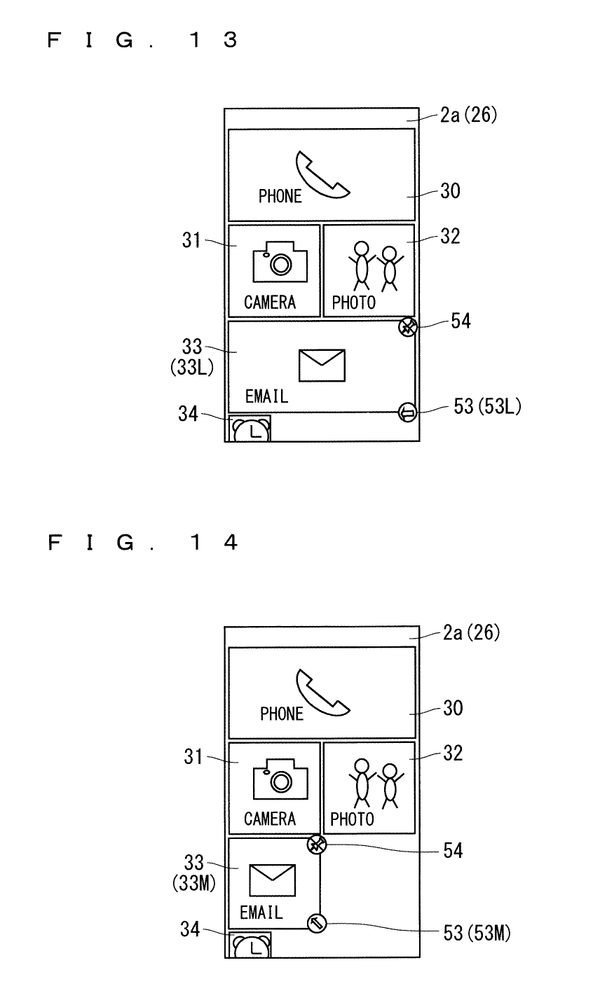

The controller 10 includes a central processing unit (CPU) 11, a digital signal processor (DSP) 12, and storage 103, and can control other components of the electronic apparatus 1 to perform overall control of operation of the electronic apparatus 1. The storage 13 is configured by read only memory (ROM), random access memory (RAM), and the like. The storage 13 can store a main program Pg1, a plurality of application programs Pg2 (hereinafter, simply referred to as “applications Pg2”), and the like. The main program Pg1 is a control program for controlling operation of the electronic apparatus 1, specifically, components, such as the wireless communication module 14 and the display 26, of the electronic apparatus 1. The main program Pg1 and the applications Pg2 can be read by the CPU 11 and the DSP 12, which are processors included in the electronic apparatus 1. Various functions relating to the electronic apparatus 1 are achieved by the CPU 11 and the DSP 12 running the main program Pg1. Although the electronic apparatus 1 includes a single CPU 11 and a single DSP 12 in one embodiment, the electronic apparatus 1 may include a plurality of CPUs 11 and a plurality of DSPs 12. This means that the electronic apparatus 1 may include at least one CPU 11 and at least one DSP 12. The at least one CPU 11 and the at least one DPS 12 may cooperate with each other to achieve various functions relating to the electronic apparatus 1. The controller 10 may not include the storage 13 as illustrated in FIG. 13. This means that the storage 13 may be provided separately from the controller 10.

The storage 13 can store, as the applications Pg2, a phone application for performing communication with another mobile phone and an email application for sending and receiving emails, for example. The applications Pg2 are read and run during running of the main program Pg1 to achieve functions, such as functions to perform communication and to send an email, in the electronic apparatus 1. In FIG. 3, only a single application Pg2 is shown to avoid complications.

The wireless communication module 14 has an antenna 15. The wireless communication module 14 can transmit and receive, from the antenna 15, a communication signal to and from a mobile phone other than the electronic apparatus 1 or a communication apparatus, such as a web server, connected to the Internet through the base station and the like.

The display 26 includes the display area 2a and the display device 16. The display device 16 is a liquid crystal display or an organic EL display, for example. As described above, in the display 26, the variety of information displayed by the display device 16 is viewed from the outside the electronic apparatus 1 through the display area 2a.

The touch panel 17 is a projected capacitive touch panel, for example. The touch panel 17 is stuck on the back side of the cover panel 2, and includes two sheet-like electrode sensors facing each other. When the user contacts the display area 2a of the display 26 with the operator, such as a finger, capacitance in a portion of the touch panel 17 facing the operator changes. The touch panel 17 can output an electrical signal to the controller 10 in accordance with the change in capacitance. As described above, the touch panel 17 can detect the contact of the operator with the display 26 (display area 2a). The touch panel 17 can also detect operations performed on the operation keys 4a, 4b, and 4c, and transmit electrical signals to the controller 10. The touch panel 17 functions as an operation detector configured to detect an operation performed with the operator on the display area 2a of the display 26. The user can provide various instructions to the electronic apparatus 1 also by operating the display 26 with an operator other than the finger, such as, a pen for electrostatic touch panels including a stylus pen.

In a case where detection sensitivity of the touch panel 17 is set to be high, capacitance in the portion of the touch panel 17 facing the operator changes even if the operator is not in contact with the display area 2a but is in close proximity to the display area 2a. Thus, the touch panel 17 can also detect the close proximity of the operator to the display 26 (display area 2a). This means that the touch panel 17 can detect the contact and the close proximity of the operator with and to the display 26 (display area 2a). In one embodiment, the state of the operator being in contact with the display 26 (display area 2a) includes the state of the operator being in close proximity to the display 26. This means that detection by the touch panel 17 of the contact of the operator with the display 26 includes detection by the touch panel 17 of the close proximity of the operator to the display 26.

The side keys 7a, 7b, and 7c can transmit electrical instruction signals to the controller 10 upon being pressed. The microphone 18 can receive voice of the user and the like during communication, convert the voice and the like as input into electrical signals, and output the electrical signals to the controller 10. The receiver 19 can convert electrical sound signals input from the controller 10 during communication and the like into sound, and output the sound to provide received sound to the user. The front-side imaging module 6 and the back-side imaging module 8 can capture still images and moving images.

<Start Screen Displayed by Display>

The start screen displayed by the display 26 immediately after activation of the electronic apparatus 1 or when the operation key 4b is operated is described herein. An image for causing the electronic apparatus 1 to run an application is shown in the start screen. Such an image is also referred to as a “tile” in one embodiment. An “image” hereinafter refers to the “image for causing the electronic apparatus 1 to run the application” unless otherwise indicated. By performing an operation indicating running of an application on an image displayed by the display 26, an application corresponding to the image on which the operation has been performed is run in the electronic apparatus 1. The image includes a graphic and the like representing an application corresponding to the image, which are is described in detail below. The user can know the application corresponding to the image based on information on the graphic and the like included in the image.

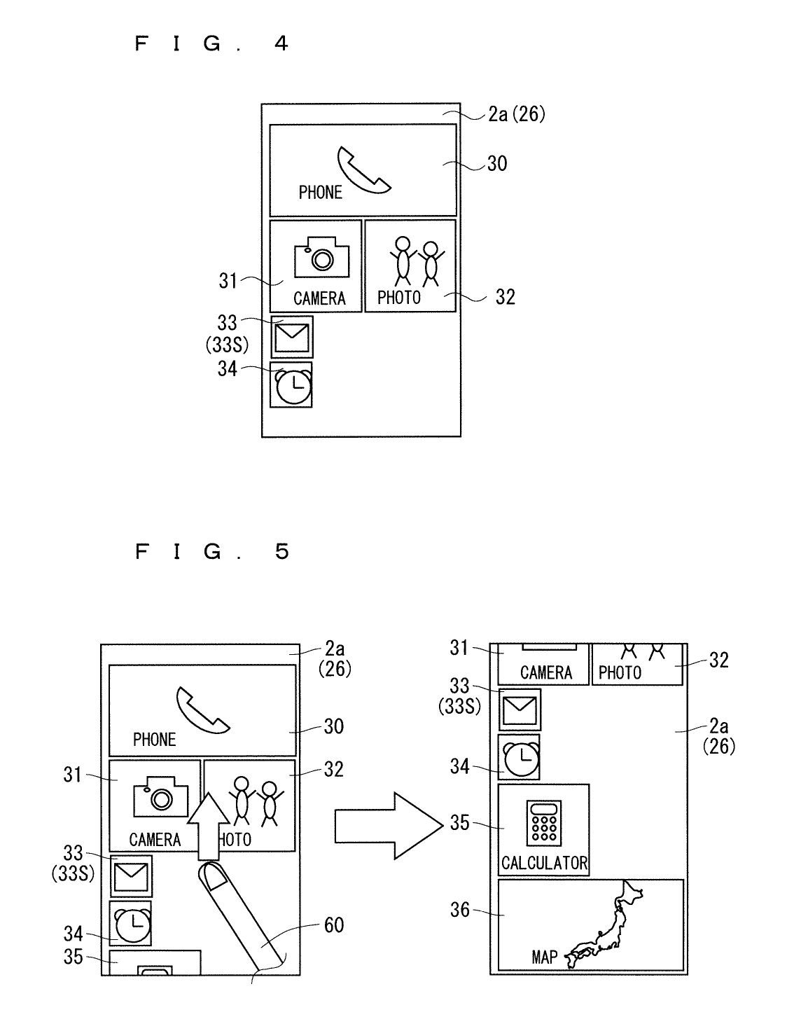

FIG. 4 illustrates an example of the start screen displayed by the display 26. Images 30, 31, 32, 33, and 34 are displayed in the start screen illustrated in FIG. 4. The image 30 is an image corresponding to the phone application. By the user performing an operation indicating running of the application on the image 30, for example, the phone application is run in the electronic apparatus 1. The image 31 is an image corresponding to a camera application for causing the front-side imaging module 6 or the back-side imaging module 8 to capture an image. The image 32 is an image corresponding to a display application for causing the display 26 to display image data stored in the storage 13 of the electronic apparatus 1. The image 33 is an image corresponding to the email application. The image 34 is an image corresponding to an alarm application for notifying the user of set time.

In a case where many images are arranged in the start screen, one or more images are arranged outside the display 26. In this case, the one or more images arranged outside the display 26 can be displayed on the display 26 by performing a flick operation with the operator on the display 26 in a direction in which the user wants to scroll the start screen. The flick operation refers to an operation to wipe the display 26 with the operator. Specifically, the flick operation refers to an operation to move the operator by a predetermined distance or more within a predetermined time with the operator being in contact with the display 26, and then release the operator from the display 26.

FIG. 5 illustrates an example of display of the start screen in which some images are displayed outside the display range of the display 26. As illustrated in a left portion of FIG. 5, the display 26 displays part of an image 35 and the images 30, 31, 32, 33, and 34 before the flick operation is performed with the operator 60. The remaining part of the image 35 and an image 36 are arranged outside the display 26. When an upward flick operation is performed with the operator 60 on the display 26 as illustrated in FIG. 5, the display range of the display 26 in the start screen is moved downwards. As illustrated in a right portion of FIG. 5, the display 26 displays the images 33, 34, 35, and 36 and parts of the images 31 and 32 after the flick operation is performed with the operator 60. The image 30 is out of the display range of the display 26 due to movement of the display range.

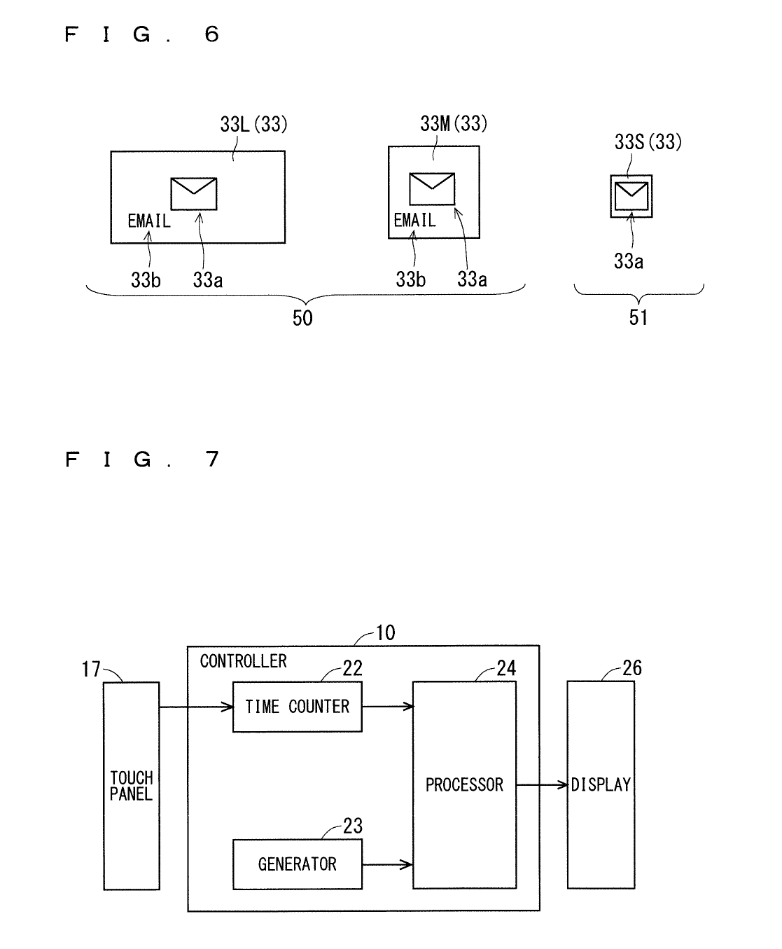

As illustrated in FIGS. 4 and 5, the images displayed in the start screen are not uniform in size. The difference in information included in the images caused by the difference in sizes of the images is described with reference to FIG. 6. Description is given by taking, as an example, a case where there are images of three sizes in one embodiment. The size of an image displayed in the start screen can be changed in a case where an operation mode of the electronic apparatus 1 is set to a mode in which the size and the position of the image are changed.

FIG. 6 illustrates images 33 each corresponding to the email application. FIG. 6 illustrates images (images 33L, 33M, and 33S in descending order of size) of three sizes each corresponding to the email application.

The image 33L is the largest image of all the three images. As illustrated in FIG. 6, the image 33L has a horizontal rectangular shape with an aspect ratio of 1:2, for example. The image 33L includes a graphic 33a representing the email application and text information 33b.

As the graphic included in the image, a graphic representing an application corresponding to the image is selected. As illustrated in FIG. 6, the graphic 33a is a graphic of an envelope representing the email application.

The text information included in the image indicates a name of the application corresponding to the image. The text information 33b illustrated in FIG. 6 indicates “EMAIL”.

The image 33M is an image of an intermediate size among the three images. As illustrated in FIG. 6, the image 33M has a square shape obtained by halving a lateral size of the image 33L, for example. The image 33M includes the graphic 33a and the text information 33b as with the image 33L.

The image 33S is the smallest image of all the three images. As illustrated in FIG. 6, the image 33S has a square shape obtained by halving a longitudinal size and a lateral size of the image 33M, for example. The image 33S does not include the text information 33b, and includes the graphic 33a.

The images 33L and 33M include both the graphic 33a and the text information 33b. Thus, in a case where the images 33 have the sizes of the images 33L and 33M, the user can easily know that the images 33L and 33M correspond to the email application based on the graphic 33a and the text information 33b included in the images 33L and 33M. In one embodiment, a size of an image including a graphic and text information is referred to as a “large size 50”. The large size 50 is also referred to as a “first size 50”.

On the other hand, the image 33S includes the graphic 33a but does not include the text information 33b. In one embodiment, a size of an image not including text information but including a graphic is referred to as a “small size 51”. The small size 51 is also referred to as a “second size 51”. When the image 33 is the image 33S of the small size 51, the user has to recognize that the image 33S corresponds to the email application based on the graphic 33a. It is thus difficult for the user to know the application corresponding to the image 33S. In one embodiment, the display 26 is caused to display the text information 33b by functional blocks and processing described below.

An image corresponding to an application may not include a graphic representing the application depending on the type of the application. For example, an image corresponding to the display application may be a still image that can be displayed during running of the display application and is stored in the storage 13, and thus the image corresponding to the display application may not include a graphic representing the display application.

<Functional Blocks of Controller>

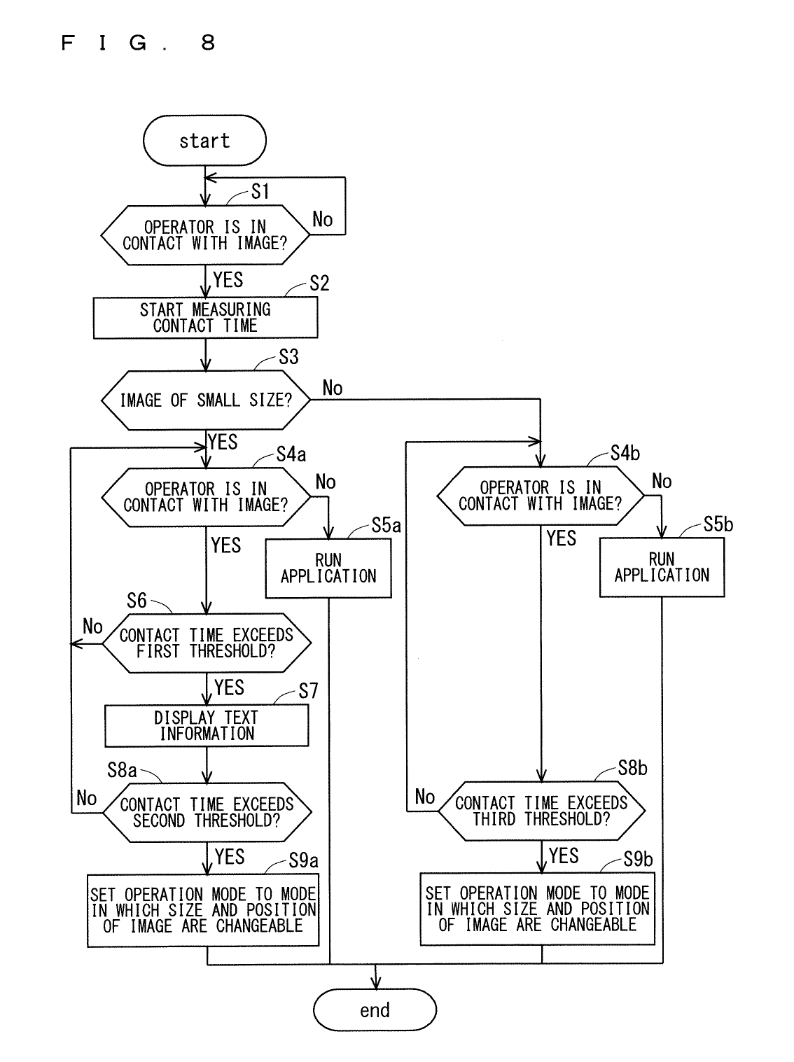

In the controller 10, a plurality of functional blocks are formed by running the main program Pg1. FIG. 7 illustrates some of the plurality of functional blocks formed in the controller 10. As illustrated in FIG. 7, the controller 10 includes a time counter 22, a generator 23, and a processor 24.

The time counter 22 can measure a contact time of the operator 60 with an image. The contact time of the operator 60 with the image is hereinafter simply referred to as a “contact time”. When judging that the operator 60 is in contact with the image based on results of detection by the touch panel 17, the time counter 22 can start measuring the contact time. When results of judgment are changed from those indicating that the operator 60 is in contact with the image to those indicating that the operator 60 is not in contact with the image (i.e., when the operator 60 contacts the image, and is then released from the image), the time counter 22 can finish measuring the contact time, and transmit the contact time to the processor 24. Even if measurement of the contact time is not finished, the time counter 22 can transmit the contact time having measured so far (i.e., until a request is received from the processor 24) from the contact of the operator 60 with the image to the processor 24 at the request of the processor 24.

The generator 23 can specify the size of the image displayed by the display 26. In one embodiment, the generator 23 can specify one of the three sizes as the size of the image. The size of the image specified by the generator 23 is transmitted to the processor 24.

The processor 24 can perform processing based on the contact time measured by the time counter 22 and the size of the image specified by the generator 23. Processing performed by the processor 24 is described in the following description on a flow of processing performed by the controller 10.

<Flow of Processing Performed by Controller>

The flow of processing in one embodiment is described herein with reference to FIG. 8. FIG. 8 illustrates the flow of processing in one embodiment.

First, the time counter 22 judges whether the operator 60 is in contact with an image based on results of detection by the touch panel 17 (step S1). When the time counter 22 judges that the operator 60 is not in contact with the image (NO in step S1), processing in step S1 is repeatedly performed until the time counter 22 judges that the operator 60 is in contact with the image. In one embodiment, the image with which the operator 60 is in contact is also referred to as a “first image”.

When the time counter 22 judges that the operator 60 is in contact with the image (YES in step S1), the time counter 22 starts measuring the contact time (step S2). The processor 24 then judges whether the size of the first image with which the operator 60 is in contact is the small size 51 based on the size of the image specified by the generator 23 (step S3). In the following description, processing performed in a case where the size of the first image is the small size 51 is described first, and processing performed in a case where the size of the first image is the large size 50 is then described.

<Processing Performed in Case where First Image has Small Size>

When the size of the first image is the small size 51 (YES in step S3), the processor 24 checks whether the operator 60 is in contact with the first image based on results of judgement by the time counter 22 (step S4a). Processing in step S4a is processing to check whether the contact of the operator 60 with the first image continues. When the operator 60 is not in contact with the first image (NO in step S4a), the processor 24 runs an application corresponding to the first image (step S5a). This means that the processor 24 runs the application corresponding to the first image of the small size 51 when the operator 60 contacts the first image and is then released from the first image. Processing to run the application corresponding to the first image of the small size 51 in step S5a is referred to as first processing.

On the other hand, when the operator 60 is in contact with the first image (YES in step S4a), the processor 24 checks whether the contact time is longer than a first threshold (step S6). When the contact time is shorter than the first threshold (No in step S6), the processor 24 returns to processing in step S4a. When the contact time is longer than the first threshold (YES in step S6), the processor 24 causes the display 26 to display the text information (step S7). Processing to cause the display 26 to display the text information in step S7 is referred to as second processing. In the second processing, the text information displayed by the display 26 is the text information included in the first image when the first image has the large size 50. By causing the display 26 to display the text information included in the first image of the large size 50 in step S7 in a case where the first image of the small size 51 not including the text information is displayed, the user can know the application corresponding to the first image. How to display the text information in the second processing is described below.

When the text information is displayed, the processor 24 checks whether the contact time is longer than a second threshold that is longer than the first threshold (step S8a). When the contact time is longer than the second threshold (YES in step S8a), the processor 24 sets the operation mode of the electronic apparatus 1 to a mode in which the size and the position of the first image are changeable (step S9a). The mode which is set by operating the first image of the small size 51 and in which the size and the position of the first image are changeable is also referred to as a first change mode. The first change mode is described in detail below. Processing to change the operation mode in step S9a is referred to as third processing. When the contact time is shorter than the second threshold (NO in step S8a), processing returns to processing in step S4a.

The text information displayed in step S7 is hidden when the application corresponding to the first image is run (step S5a) or when the operation mode of the electronic apparatus 1 is set to the first change mode (step S9a), although this is omitted in FIG. 8 for simplicity. The text information displayed in step S7 is continuously displayed by the display 26 until processing in step S5a or step S9a is performed.

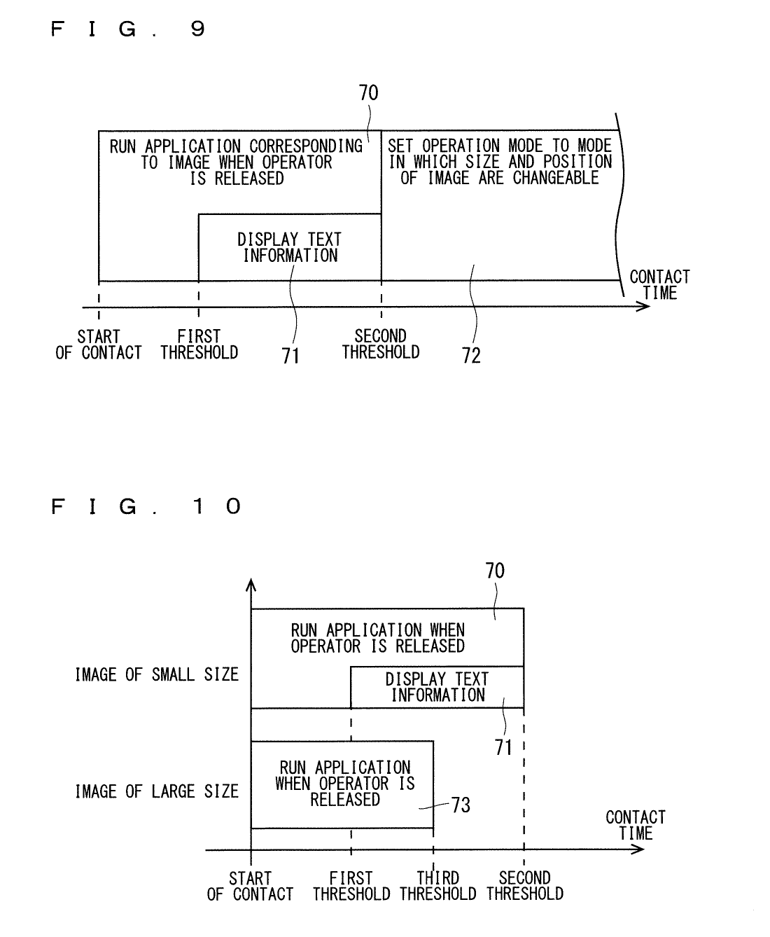

FIG. 9 illustrates the relationship between the above-mentioned processing performed when the size of the first image is the small size 51 and the contact time. The horizontal axis of FIG. 9 represents the contact time measured by the time counter 22. As illustrated in FIG. 9, during a time 70 from the contact of the operator 60 with the first image to the second threshold, the first processing to run the application corresponding to the first image is performed by releasing the operator 60 from the first image.

The second threshold is longer than the first threshold, and, during a time 71 from the first threshold to the second threshold, the second processing to cause the display 26 to display the text information is performed. During the time 71 from the first threshold to the second threshold, the user can know the application corresponding to the first image by checking the displayed text information, and cause the electronic apparatus 1 to run the application corresponding to the first image by releasing the operator 60 from the display 26. In a case where the user wants to cause the electronic apparatus 1 to run the application corresponding to the first image, and there is no need to check the text information, the user can cause the electronic apparatus 1 to run the application without causing the display 26 to display the text information by releasing the operator 60 from the first image before the contact time exceeds the first threshold. In a case 72 where the contact time exceeds the second threshold, the operation mode of the electronic apparatus 1 is set to the change mode in which the size and the position of the first image are changeable.

<Processing Performed in Case where First Image has Large Size>

Processing performed by the controller 10 in a case where the size of the first image is the large size 50 is described next. Referring back to step S3 of FIG. 8, when the size of the first image is not the small size 51 (NO in step S3), the processor 24 checks whether the operator 60 is in contact with the first image based on results of judgment by the time counter 22 (step S4b). When the operator 60 is not in contact with the first image (NO in step S4b), the processor 24 runs the application corresponding to the first image (step S5b). This means that the processor 24 runs the application corresponding to the first image when the operator contacts the first image of the largest size or the first image of the intermediate size and is then released from the first image of the largest size or the first image of the intermediate size. Processing to run the application corresponding to the first image of the large size 50 in step S5b is referred to as fourth processing.

On the other hand, when the operator 60 is in contact with the first image (YES in step S4b), the processor 24 checks whether the contact time is longer than a third threshold (step S8b). When the contact time is longer than the third threshold (YES in step S8b), the processor 24 sets the operation mode of the electronic apparatus 1 to the mode in which the size and the position of the first image are changeable (step S9b). The mode which is set by operating the first image of the large size 50 and in which the size and the position of the first image of the large size 50 are changeable is also referred to as a second change mode. The second change mode is described in detail below along with the above-mentioned first change mode. Processing to change the operation mode of the electronic apparatus 1 to the second change mode in step S9b is referred to as fifth processing. When the contact time is shorter than the third threshold (NO in step S8b), processing returns to processing in step S4b.

FIG. 10 illustrates a time required for processing. The horizontal axis of FIG. 10 represents the contact time measured by the time counter 22. FIG. 10 illustrates processing performed when the size of the first image is the small size 51 (in an upper portion of FIG. 10) and processing performed when the size of the first image is the large size 50 (in a lower portion of FIG. 10). When the size of the first image is the small size 51, the application corresponding to the first image is run by releasing the operator 60 from the first image during the time 70 from the contact of the operator 60 with the first image to the second threshold. When the size of the first image is the large size 50, the application corresponding to the first image is run by releasing the operator 60 from the first image during a time 73 from the contact of the operator 60 with the first image to the third threshold.

As illustrated in FIG. 10, it is desirable that the third threshold be shorter than the second threshold. When the size of the first image is the small size 51, the user may perform an operation to run the application on the first image after checking the displayed text information during the time 71 from the first threshold to the second threshold. It is thus preferable to set a relatively long time to the second threshold, which is a timing at which the operation mode of the electronic apparatus 1 is set to the first change mode, in view of a time required for the user to check the text information.

On the other hand, the text information is included in the first image when the size of the first image is the large size 50. This means that the user can check the text information included in the first image before performing an operation on the first image. The user thus does not check the text information after starting performing an operation on the first image, and there is no need to consider the time required for the user to check the text information to set the third threshold.

As described above, when the third threshold is set to be shorter than the second threshold, for example, by setting the second threshold to five seconds and setting the third threshold to three seconds, wasted time for a user who wants to set the operation mode of the electronic apparatus 1 to the second change mode to change the size or the position of the first image can be eliminated, and operability of the electronic apparatus 1 is improved.

It is also desirable that the first threshold be shorter than the third threshold as illustrated in FIG. 10. When the first threshold is shorter than the third threshold, a time between the first threshold and the second threshold can be ensured. This means that a time to display the text information can be ensured. This facilitates the user's understanding of the text information.

An example of display in the second processing to display the text information and the first and second change modes in which the size and the position of the image are changed are sequentially described.

<Example of Display of Text Information in Second Processing>

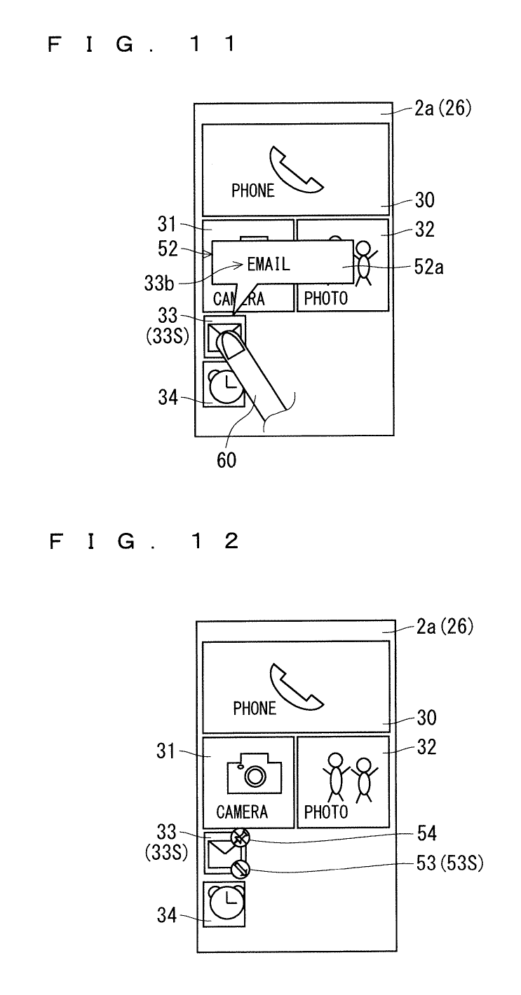

FIG. 11 illustrates an example of display of the text information of the display 26 in the second processing. FIG. 11 illustrates an example of display of the display 26 when the contact time exceeds the first threshold with the operator 60 being in contact with the image 33 (image 33S).

In one embodiment, the text information is displayed in a pop-up window. Specifically, when the contact time of the operator 60 with the image 33 (image 33S) exceeds the first threshold, the display 26 displays a contact image 52 being in contact with the image 33 as illustrated in FIG. 11. The contact image 52 includes a speech balloon-like graphic 52a and the text information 33b located in the graphic 52a. The contact image 52 may not be in contact with the image 33.

As described above, by displaying the text information 33b in a case where the image 33 (image 33S) not including the text information 33b is displayed, the user can know that the application corresponding to the image 33 (image 33S) is the email application.

In the example of FIG. 11, the text information 33b is displayed in an area other than an area in which the display 26 displays the image 33 (image 33S) being in contact with the operator 60. This suppresses the state of the text information 33b being hidden by the operator 60. The user can thus easily view the text information 33b.

<Change in Size and Position of Image (First Change Mode/Second Change Mode)>

FIG. 12 illustrates an example of display of the display 26 when the operation mode of the electronic apparatus 1 is set to the mode in which the size and the position of the first image (image 33S) are changeable by the operator 60 (not illustrated) being in contact with the image 33S for a predetermined time or more in a case where the start screen is displayed. As illustrated in FIG. 12, in one embodiment, a size change key 53 (size change key 53S) and a deletion key 54 are displayed to overlap the first image (image 33S) in the mode in which the size and the position of the image are changeable. The user can change the size or the position of the first image (image 33S) by performing an operation on the first image, the size change key 53 (53S), and the deletion key 54. When the user operates the operation key 4b after changing the size and the position of the first image (image 33S), the mode in which the size and the position of the first image (image 33S) are changeable is cancelled.

The size change key 53 (53S) is a key to change the size of the first image (image 33S). When the operator 60 contacts the size change key 53 and is then released from the key 53, i.e., when a tap operation is performed on the size change key 53 with the operator 60, the display 26 displays the first image (image 33L) of the largest size as illustrated in FIG. 13. A size change key 53L and the deletion key 54 are displayed on the first image (image 33L) illustrated in FIG. 13.

The size change key 53S includes an arrow. The arrow included in the size change key 53S illustrated in FIG. 12 points outwards relative to the first image (image 33S) to indicate that the size change key 53S is a key to increase the size of the first image (image 33S), and points diagonally downwards relative to the first image (image 33S) to indicate that the first image (image 33S) is expanded in the vertical direction and in the horizontal direction.

On the other hand, the size change key 53L displayed to overlap the first image (image 33L) of FIG. 13 includes an inward arrow relative to the first image (image 33L). The inward arrow indicates that the size change key 53L is a key to reduce the size of the first image (image 33L). Furthermore, the arrow included in the size change key 53L points in the longitudinal direction of the first image (image 33L) to indicate that the size of the first image (image 33L) is reduced in the longitudinal direction.

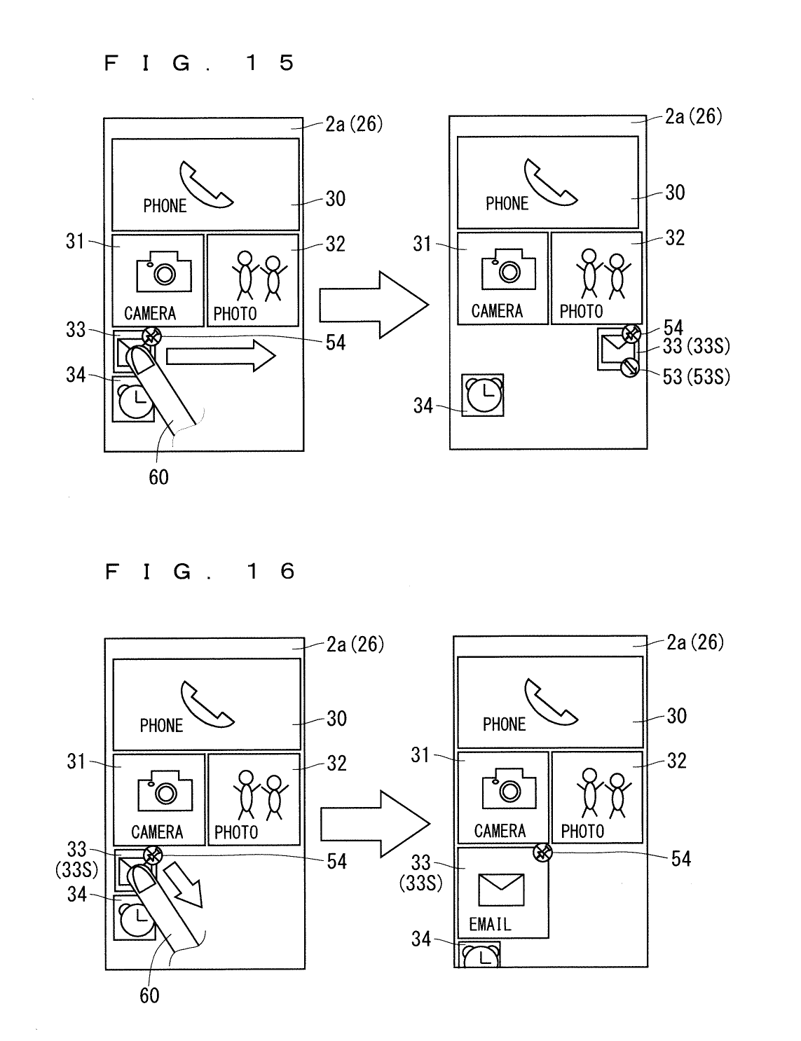

FIG. 14 illustrates an example of display of the display 26 after the operator 60 contacts the size change key 53L illustrated in FIG. 13 and is then released from the size change key 53L. In the example of display of the display 26 illustrated in FIG. 14, the first image (image 33M) of the intermediate size is displayed. A size change key 53M and the deletion key 54 are displayed to overlap the first image (image 33M) in FIG. 14. The size change key 53M includes an arrow pointing diagonally inwards relative to the first image (image 33M), and the arrow indicates that the size of the first image (image 33M) is reduced while maintaining the aspect ratio by operating the size change key 53M. Display returns to the display illustrated in FIG. 12 when the size change key 53M is operated.

In a case where the operation mode of the electronic apparatus 1 is set to the mode in which the size and the position of the image 33L are changeable by operating the image 33L with the operator 60 when the start screen is displayed, the display 26 performs display as illustrated in FIG. 13. In a case where the operation mode of the electronic apparatus 1 is set to the mode in which the size and the position of the image 33M are changeable by operating the image 33M with the operator 60 when the start screen is displayed, the display 26 performs display as illustrated in FIG. 14.

The deletion key 54 is a key to delete the first image from the start screen. When the operator 60 contacts the deletion key 54 and is then released from the key 54, i.e., when the tap operation is performed on the deletion key 54 with the operator, the first image is deleted from the display 26.

The change in position of the first image is described next. The position of the first image is changed by performing an operation to move the operator 60 to an area to which the user wants to move the first image with the operator 60 being in contact with the first image. FIG. 15 illustrates the change in position of the first image. FIG. 15 illustrates an example in which the position of the image 33 (image 33S) is changed. As illustrated in FIG. 15, when the operator 60 is moved to the right with the operator 60 being in contact with the image 33 (image 33S), the image 33S is moved to the right.

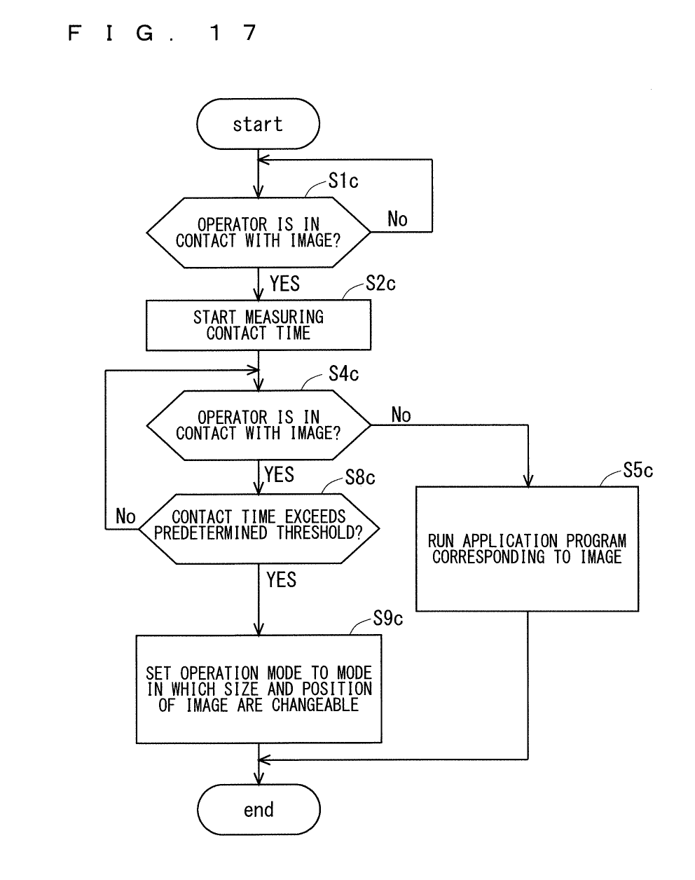

As illustrated in FIG. 16, the size of the first image (image 33S) may be changed by performing an operation to move the operator 60 with the operator 60 being in contact with the image 33 (image 33S). In this case, the size of the first image (image 33S) is changed in accordance with the direction and the amount of movement of the operator 60. For example, the size of the first image is increased when the operator 60 is moved outwards relative to the first image, and is reduced when the operator 60 is moved inwards relative to the first image. For example, the size of the first image is increased or reduced by one step when the amount of movement of the operator 60 is equal to or smaller than a predetermined threshold, and is increased or reduced by two steps when the amount of movement of the operator 60 is larger than the threshold.

In the example illustrated in FIG. 16, the operator 60 is moved outwards relative to the first image (image 33S) by a short distance with the operator 60 being in contact with the first image (image 33S). This operation increases the size of the first image by one step from the size of the first image (image 33S) before the operation, and causes the display 26 to display the first image (image 33M) of the intermediate size. In this case, the size of the first image can be changed by performing an operation on the first image, and thus the above-mentioned size change key 53 is no longer needed. The operation performed on the first image illustrated in FIG. 16 is similar to the above-mentioned operation to change the position of the first image. Thus, in a case where the size of the first image is changed by performing an operation on the first image, the position of the first image is not changed.

The size of the first image (image 33S) may be changed by moving the operator 60 with the operator 60 being in contact with a corner of the first image (image 33S). In this case, when the operator 60 being in contact with the corner of the first image is moved, the size of the first image is changed so that the corner of the first image (image 33S) is located at the destination of the operator 60. When the operator 60 is released from the corner of the first image after being moved, one of predetermined sizes of the image (e.g., three sizes of the images 33S, 33M, and 33L in one embodiment) that is the closest to the size of the image immediately before the operator 60 is released from the corner of the first image is selected. The final size of the first image is set to the selected size.

<Electronic Apparatus to Be Compared>

An electronic apparatus (hereinafter, referred to as a “compared apparatus”) to be compared with the electronic apparatus 1 in one embodiment is described herein. FIG. 17 illustrates a flow of processing performed by the compared apparatus corresponding to the flow of processing performed by the electronic apparatus 1 illustrated in FIG. 8.

First, the time counter 22 judges whether the operator 60 is in contact with an image based on results of detection by the touch panel 17 (step S1c). When the time counter 22 judges that the operator 60 is not in contact with the image (NO in step S1c), processing in step S1c is repeatedly performed until the time counter 22 judges that the operator 60 is in contact with the image. When the time counter 22 judges that the operator 60 is in contact with the image (YES in step Sc1), the time counter 22 starts measuring the contact time (step S2c).

When the time counter 22 starts measuring the contact time in step S2c, the processor 24 checks whether the operator 60 is in contact with the image (step 54c). When the operator 60 is not in contact with the image (NO in step S4c), an application corresponding to the image is run (step 55c). This means that the application corresponding to the image is run when the tap operation is performed on the image.

On the other hand, when the operator 60 is in contact with the image (YES in step 54c), the processor 24 checks whether the contact time exceeds a predetermined threshold (step S8c). When the contact time is shorter than the predetermined threshold (NO in step 58c), processing returns to processing in step S4c. When the contact time is longer than the predetermined threshold (YES in step 58c), the processor 24 sets the operation mode of the compared apparatus to the mode in which the size and the position of the image are changeable (step 59c). This means that the operation mode of the compared apparatus is set to the mode in which the size and the position of the image are changeable when a touch operation is performed on the image for a certain time.

As described above, processing equivalent to the second processing to display the text information in the electronic apparatus 1 is not performed in the compared apparatus even when the first image has the small size 51, and does not include the text information. Thus, in a case where the user cannot know the application corresponding to the first image only from the graphic included in the first image, the user has to change the size of the first image to the large size 50 at which the first image includes the graphic and the text information, and check the text information, for example.

In the electronic apparatus 1 in one embodiment, however, the display 26 displays the text information in the second processing when the first image has the small size 51. The user can thus know the application corresponding to the first image based on the text information displayed by the display 26. This means that, in the electronic apparatus 1 in one embodiment, the text information can be checked without changing the size of the first image when the user cannot know the application corresponding to the first image only from the graphic included in the first image of the small size 51. As a result, operability of the electronic apparatus 1 is improved.

In the electronic apparatus 1 in one embodiment, the text information is displayed when the operator 60 is in contact with the image of the small size 51. The user who has viewed the text information can thus cause the electronic apparatus 1 to run the application corresponding to the image by releasing the operator 60 from the image. As a result, operability of the electronic apparatus 1 is further improved.

In the electronic apparatus 1 in one embodiment, the application corresponding to the first image is run when the operator 60 is released from the first image in a case where the contact time of the operator 60 with the first image is equal to or shorter than the first threshold. Thus, in a case where the user knows the application corresponding to the image of the small size 51, the user can cause the electronic apparatus 1 to run the application corresponding to the image without displaying the text information by releasing the operator 60 from the image before the contact time exceeds the first threshold. This means that, in a case where the user knows the application corresponding to the image of the small size 51, the user can immediately cause the electronic apparatus 1 to run the application corresponding to the image. As a result, operability of the electronic apparatus 1 is improved.

In the electronic apparatus 1 according to one embodiment, the text information is displayed when the contact time of the operator 60 with the image of the small size 51 is short, and the operation mode of the electronic apparatus 1 is set to the first change mode when the contact time is long. The user can thus set the operation mode of the electronic apparatus 1 to the first change mode after causing the electronic apparatus 1 to display the text information only by allowing the operator 60 to remain in contact with the image. As a result, operability of the electronic apparatus 1 is further improved.

<Modifications of how to Display Text Information>

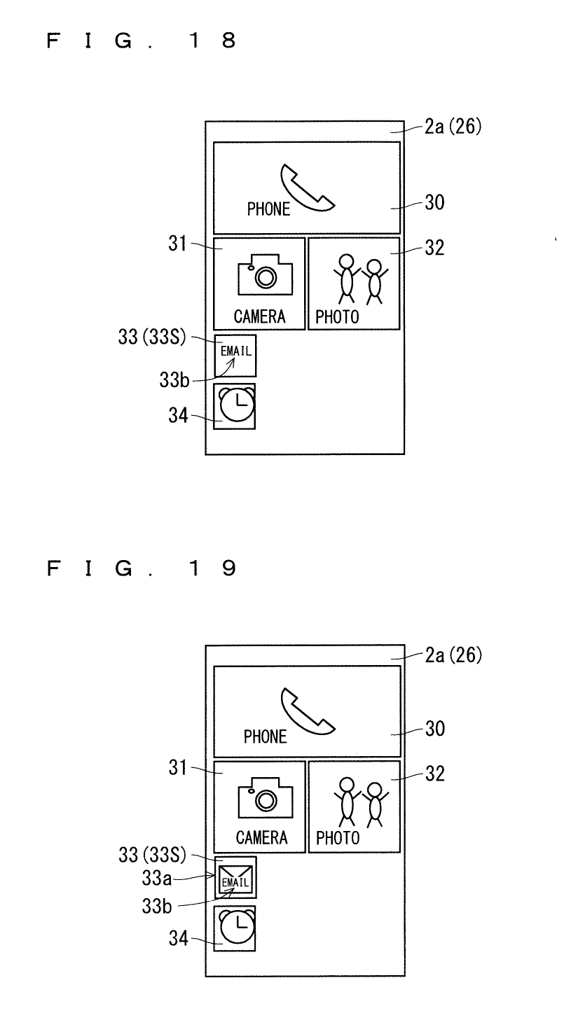

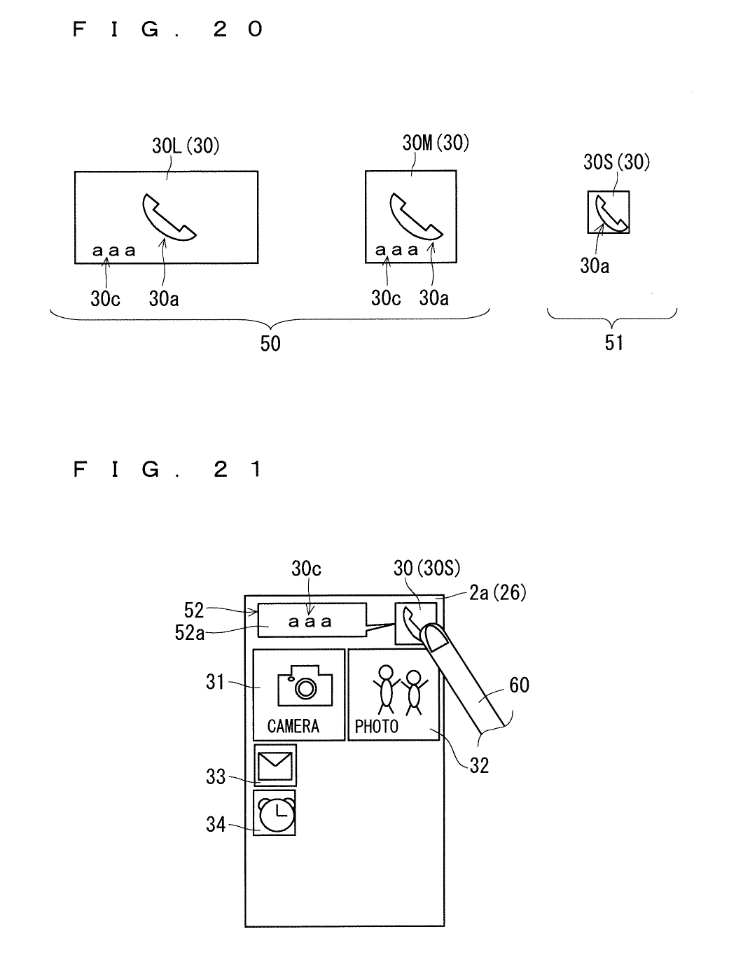

In one embodiment described above, an example in which the display 26 displays the text information in the second processing by including the text information in the contact image 52 is described. An example in which the display 26 displays the text information displayed in the second processing by including the text information in the first image is described herein with reference to FIGS. 18 and 19.

FIGS. 18 and 19 illustrate examples of display when the text information is displayed with respect to the image 33S in the second processing. The operator 60 is omitted from FIGS. 18 and 19 to increase visibility of the first image (image 33S), although the operator 60 is actually in contact with the image 33 (image 33S), which is the first image.

The first image (image 33S) illustrated in FIG. 18 does not include the graphic 33a, and includes the text information 33b. Before the text information is displayed in the second processing, the first image (image 33S) does not include the text information 33b, and includes the graphic 33a as illustrated in FIG. 4. This means that, in the example illustrated in FIG. 18, the text information 33b is caused to be included in the first image (image 33S), and the graphic 33a having been included in the first image (image 33S) is caused not to be included in the first image (image 33S) in the second processing (more specifically, in step S7 of FIG. 8). The text information 33b can easily be viewed as the graphic 33a is caused not to be included in the first image (image 33S).

The first image (image 33S) illustrated in FIG. 19 includes the graphic 33a and the text information 33b. The text information 33b is herein located on the graphic 33a. The text information 33b can thus easily be viewed without being hidden by the graphic 33a.

<Modifications of Text Information>

In the above-mentioned example, a case where the text information included in the image of the large size 50 indicates the name of the application corresponding to the image is described. A case where the text information included in the image of the large size 50 does not include the name of the application is described herein. In this modification, the image of the large size 50 includes information relating to the application other than the name of the application corresponding to the image, for example.

FIG. 20 illustrates images 30 each corresponding to the phone application. FIG. 20 illustrates images (images 30L, 30M, and 30S in descending order of size) of three sizes each corresponding to the phone application.

Text information 30c included in each of the images 30L and 30M illustrated in FIG. 20 is not information indicating the name of the phone application (e.g., not text information 30b indicating “PHONE”). In FIG. 20, although the text information 30c indicates “aaa”, the text information 30c indicates a name of a company (carrier) providing a communication service in which the electronic apparatus 1 is used, for example. The text information 30c does not indicate the name of the application, but is text information relating to the application, so that the user can know the application corresponding to the image including the text information 30c based on the text information 30c.

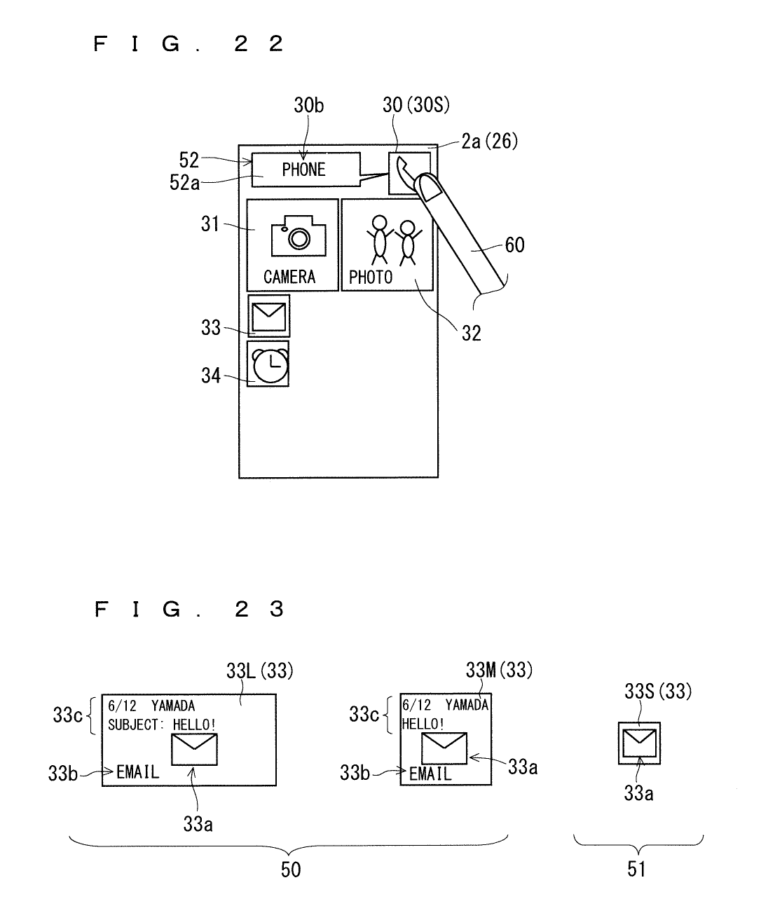

FIGS. 21 and 22 illustrate examples of display of the display 26 when the second processing is performed with the operator 60 being in contact with the image 30S in a case where the start screen is displayed. In the example illustrated in FIG. 21, the display 26 displays the contact image 52 including the text information 30c. The user can thus know the application corresponding to the first image (image 30) based on the same information as the text information 30c included in the first image (image 30) of the large size 50 even when the size of the first image (image 30) is the small size 51.

In the example illustrated in FIG. 22, the display 26 displays the contact image 52 including the text information 30b. This means that, in this example, the text information 30b different from the text information 30c included in the first image (image 30) of the large size 50 is displayed in the second processing. The text information 30b displayed in the second processing, however, indicates the name of the application corresponding to the first image (image 30), so that the user can know the application corresponding to the first image (image 30) based on the text information 30b.

As the text information included in the image of the large size 50, text information obtained by one of functions (hereinafter, referred to as the “one of the functions of the application”) achieved by running the application corresponding to the image may be included. Examples of the one of the functions of the application include a call receiving function of functions achieved by running the phone application and an email receiving function of functions achieved by running the email application. Examples of the information obtained by the one of the functions of the application include information on missed calls during running of the phone application and information on incoming emails during running of the email application.

The text information included in the image of the large size 50 may be text information used in the one of the functions of the application. An example of the text information includes a schedule on the current date used during running of a schedule application for managing the user's schedule.

The image of the large size 50 may include the name of the application corresponding to the image and information relating to the application other than the name of the application corresponding to the image.

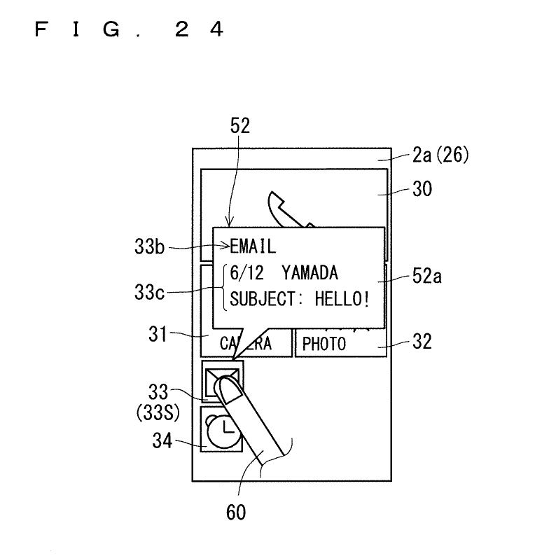

FIG. 23 illustrates images (images 33L, 33M, and 33S) of three sizes each corresponding to the email application. As illustrated in FIG. 23, the images 33L and 33M each include the text information 33b indicating the name of the email application and text information 33c relating to an incoming email obtained during performance of one of functions of the email application. The text information 33c includes information on a date of receiving the incoming email, a name of a sender of the incoming email, and a subject of the incoming email, for example.

FIG. 24 illustrates an example of display of the display 26 when the second processing is performed with the operator 60 being in contact with the image 33 (image 33S) in a case where the start screen is displayed. In FIG. 24, the contact image 52 including the text information 33b and the text information 33c is displayed. Thus, the same information as the text information 33b and the text information 33c included in the first image of the large size 50 can be checked even when the size of the first image is the small size 51.

There is no need to cause all the text information included in the first image of the large size 50 to be included in the contact image 52. For example, the display 26 may display the text information 30b and part of the text information 30c (e.g., only a name of a sender of an incoming email) by including the text information 30b and the part of the text information 30c in the contact image 52.

<Other Modifications>

Although description is given by taking, as an example, a case where the present disclosure is applied to a mobile phone in the above-mentioned example, the present disclosure is applicable to any electronic apparatus as long as the electronic apparatus includes the touch panel and the display. For example, the present disclosure is applicable to personal computers (PCs), personal digital assistants (PDAs), TVs (television receivers), and the like.

While the electronic apparatus 1 has been described in detail above, the foregoing description is in all aspects illustrative and not restrictive. Various modifications described above may be combined with one another unless any contradiction occurs. It is understood that numerous modifications not having been described can be devised without departing from the scope of the present disclosure.

1. An electronic apparatus comprising:
storage configured to store at least one application program;
a display configured to display an image that corresponds to the application program and has a variable size;
an operation detector configured to detect an operation performed with an operator on the display;
a time counter configured to measure a contact time of the operator with the image based on results of detection by the operation detector;
a generator configured to specify a size of the image; and
a processor configured to run the application program corresponding to the image when an operation performed with the operator on the image is detected, wherein
the image comprises a first image displayed by the display at a first size or a second size smaller than the first size,
in a case where the display displays the first image at the first size, the first image includes text information and a graphic representing the application program corresponding to the first image, and
in a case where the display displays, at the second size, the first image including the graphic representing the corresponding application program and not including the text information, the processor causes the display to display the text information when the operator is in contact with the first image, and the contact time with the first image is longer than a first threshold.

2. The electronic apparatus according to claim 1, wherein
in a case where the display displays, at the second size, the first image including the graphic representing the corresponding application program and not including the text information, the processor sets an operation mode of the electronic apparatus to a first change mode in which a size of the first image is changeable when the operator is in contact with the first image, and the contact time with the first image is longer than a second threshold longer than the first threshold.

3. The electronic apparatus according to claim 2, wherein
a position of the first image is changeable in the first change mode.

4. The electronic apparatus according to claim 2, wherein
in a case where the display displays the first image at the first size, the processor runs the application program corresponding to the first image when the operator contacts the first image, and is then released from the first image.

5. The electronic apparatus according to claim 4, wherein
in a case where the display displays the first image at the first size, the processor sets the operation mode of the electronic apparatus to a second change mode in which a size of the first image is changeable when the operator is in contact with the first image, and the contact time with the first image is longer than a third threshold.

6. The electronic apparatus according to claim 5, wherein
the third threshold is shorter than the second threshold.

7. The electronic apparatus according to claim 5, wherein
a position of the first image is changeable in the second change mode.

8. The electronic apparatus according to claim 1, wherein
the text information indicates a name of the application program corresponding to the first image including the text information.

9. The electronic apparatus according to claim 1, wherein
in a case where the display displays the text information when the operator is in contact with the first image, and the contact time with the first image is longer than the first threshold, the processor causes the display to display a contact image being in contact with the first image and including the text information.

10. The electronic apparatus according to claim 1, wherein
in a case where the display displays the text information when the operator is in contact with the first image of the second size, and the contact time with the first image is longer than the first threshold, the processor causes the display to display the first image including the text information.

11. The electronic apparatus according to claim 10, wherein
in a case where the display displays the text information when the operator is in contact with the first image of the second size, and the contact time with the first image is longer than the first threshold, the processor causes the display to display the first image including the text information and not including the graphic representing the corresponding application program.

12. The electronic apparatus according to claim 10, wherein
in a case where the display displays the text information when the operator is in contact with the first image of the second size, and the contact time with the first image is longer than the first threshold, the processor causes the display to display the first image including the text information located on the graphic representing the corresponding application program.

13. The electronic apparatus according to claim 1, wherein
the image comprises a second image displayed by the display at a third size or a fourth size smaller than the third size,
in a case where the display displays the second image at the third size, the second image includes a graphic representing the application program corresponding to the second image and text information not including a name of the application program, and
in a case where the display displays, at the fourth size, the second image including the graphic representing the corresponding application program and not including the text information, the processor causes the display to display the name of the application program when the operator is in contact with the second image, and the contact time with the second image is longer than a fourth threshold.

14. A non-temporary storage medium readable by a computer that stores a program, the program causing an electronic apparatus including: storage configured to store at least one application program; and a display configured to display an image that corresponds to the application program and has a variable size to perform the steps of:
(a) detecting an operation performed with an operator on the display;
(b) measuring a contact time of the operator with the image based on results of detection in the step (a);
(c) specifying a size of the image; and
(d) running the application program corresponding to the image when an operation performed with the operator on the image is detected in the step (a), wherein
the image comprises a first image displayed by the display at a first size or a second size smaller than the first size,
in a case where the display displays the first image at the first size, the first image includes text information and a graphic representing the application program corresponding to the first image, and
in the step (d),
(d-1) in a case where the display displays, at the second size, the first image including the graphic representing the corresponding application program and not including the text information, the display is caused to display the text information when the operator is in contact with the first image, and the contact time with the first image is longer than a first threshold.

15. A method for operating an electronic apparatus including storage configured to store at least one application program and a display configured to display an image that corresponds to the application program and has a variable size, the method comprising the steps of:
(a) detecting an operation performed with an operator on the display;
(b) measuring a contact time of the operator with the image based on results of detection in the step (a);
(c) specifying a size of the image; and
(d) running the application program corresponding to the image when an operation performed with the operator on the image is detected in the step (a), wherein
the image comprises a first image displayed by the display at a first size or a second size smaller than the first size,
in a case where the display displays the first image at the first size, the first image includes text information and a graphic representing the application program corresponding to the first image, and
in the step (d),
(d-1) in a case where the display displays, at the second size, the first image including the graphic representing the corresponding application program and not including the text information, the display is caused to display the text information when the operator is in contact with the first image, and the contact time with the first image is longer than a first threshold.
